(19) United States
(12) Patent Application Publication
(10) Pub. No.: US 2019/0116876 A1
(43) Pub. Date: Apr. 25, 2019

(54) Hookah Mouthpiece System

(71) Applicant: Hagop Mankikian, Glendale, CA (US)

(72) Inventor: Hagop Mankikian, Glendale, CA (US)

(21) Appl. No.: 15/792,305

(22) Filed: Oct. 24, 2017

(51) Int. Cl. A24F 1/30; A23G 3/34

(52) U.S. Cl. CPC A24F 1/30; A23V 2002/00; A23G 3/343

(57) ABSTRACT

A hookah mouthpiece system for enhancing a flavor of smoking a hookah includes a hookah that has a hose. A tube is selectively inserted into the hose and the tube is sucked on for smoking the hookah. A flavor ring is wrapped around the tube and the flavor ring is positioned in a user's mouth when the hookah is smoked. The flavor ring is infused with a flavor to enhance a flavor associated with smoking the hookah.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art including information disclosed under 37 CFR 1.97 and 1.98

The disclosure and prior art relates to mouthpiece devices and more particularly pertains to a new mouthpiece device for enhancing a flavor of smoking a hookah.

### (h) BRIEF SUMMARY OF THE INVENTION

An embodiment of the disclosure meets the needs presented above by generally comprising a hookah that has a hose. A tube is selectively inserted into the hose and the tube is sucked on for smoking the hookah. A flavor ring is wrapped around the tube and the flavor ring is positioned in a user's mouth when the hookah is smoked. The flavor ring is infused with a flavor to enhance a flavor associated with smoking the hookah.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tube of a hookah mouthpiece system according to an embodiment of the disclosure.

FIG. 2 is a front view of a tube of an embodiment of the disclosure.

FIG. 3 is a right side view of a tube of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

FIG. 6 is a perspective view of an alternative embodiment of the disclosure.

### (j) DETAILED DESCRIPTION OF THE INVENTION

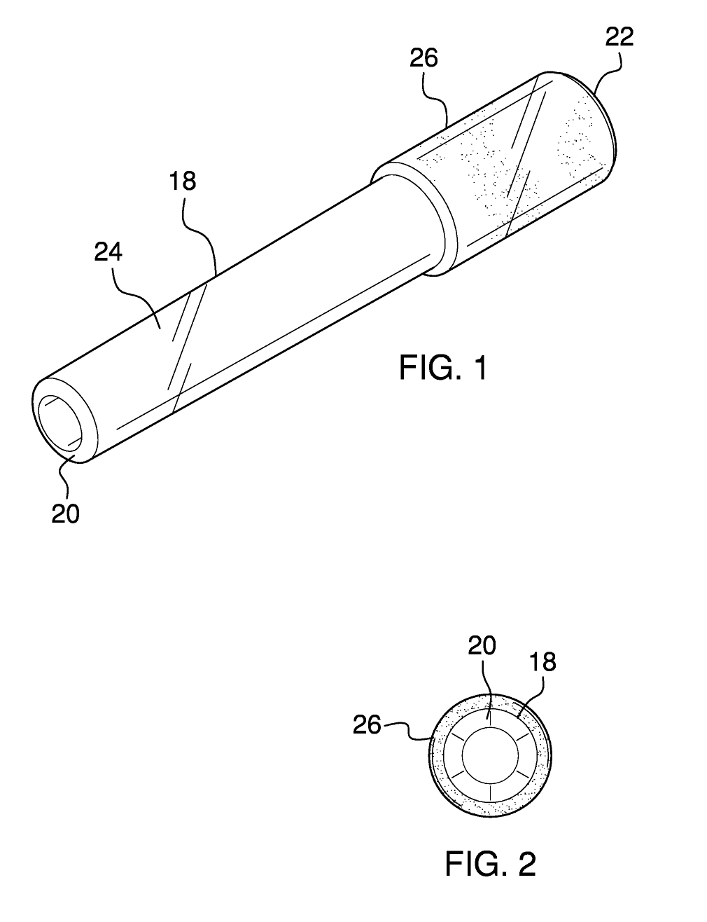

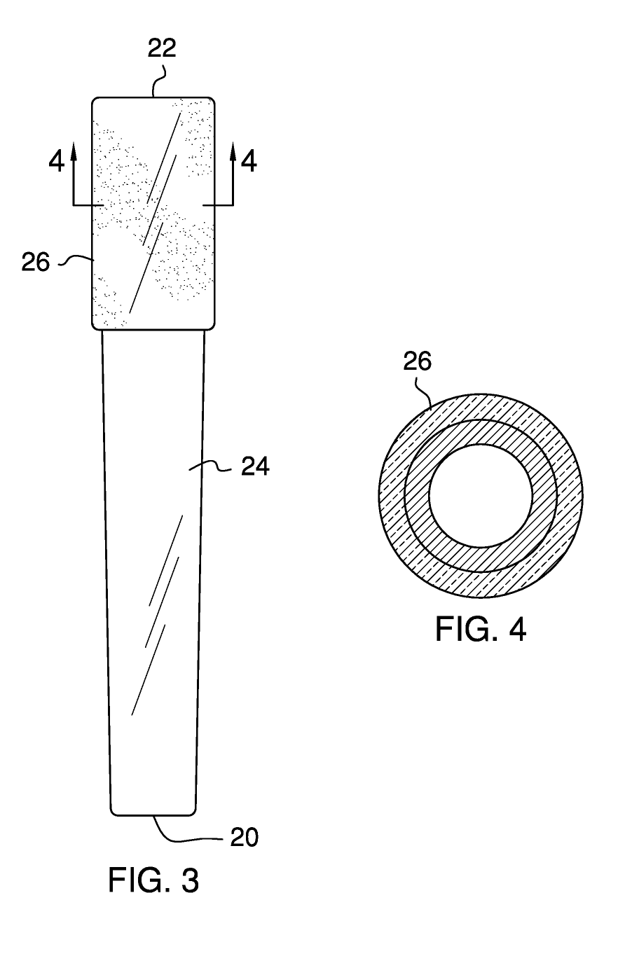

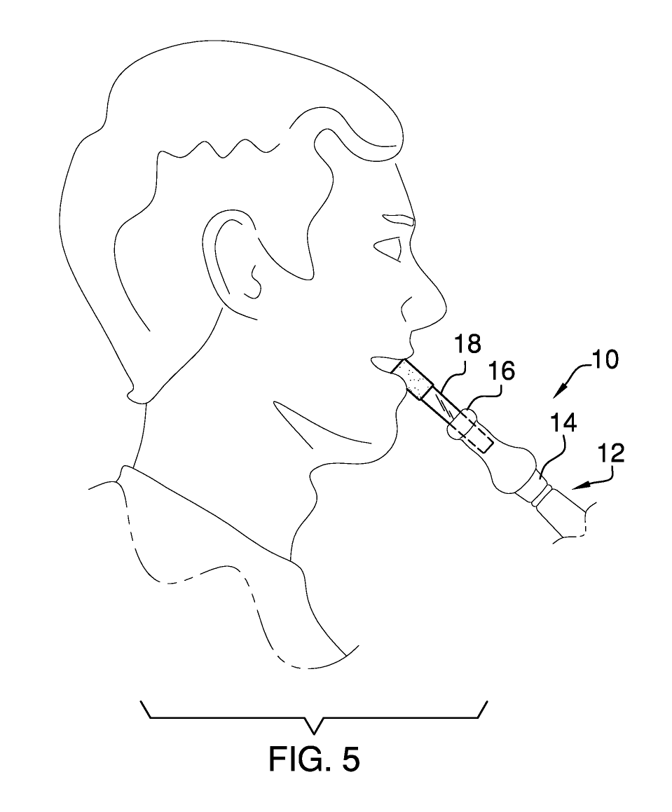

With reference now to the drawings, and in particular to FIGS. 1 through 6 thereof, a new mouthpiece device embodying the principles and concepts of an embodiment of the disclosure and generally designated by the reference numeral 10 will be described.

As best illustrated in FIGS. 1 through 6, the hookah mouthpiece system 10 generally comprises a hookah 12 that has a hose 14. The hose 14 has a distal end 16 with respect to the hookah 12 and the distal end 16 is open. A tube 18 is selectively inserted into the hose 14 and the tube 18 is sucked on for smoking the hookah 12. The tube 18 has a first end 20, a second end 22 and an outer wall 24 extending therebetween. Additionally, the tube 18 may be comprised of glass and other thermally insulating material.

The outer wall 24 tapers between the first end 20 and the second end 22 such that the first end 20 has a diameter is less than a diameter of the second end 22. The first end 20 is inserted into the distal end 16 of the hose 14 until the outer wall 24 of the tube 18 frictionally engages the hose 14. Thus, the outer wall 24 forms a fluid impermeable seal with the hose 14. The tube 18 may have a length ranging between approximately 7.0 cm and 10.0 cm.

A flavor ring 26 is provided and the flavor ring 26 is wrapped around the tube 18. The flavor ring 26 is positioned in a user's mouth when the hookah 12 is smoked. Moreover, the flavor ring 26 is infused with a flavor to enhance a flavor associated with smoking the hookah 12. The flavor may be any flavor associated with candy, sweets, fruit and any other pleasing flavor. The flavor ring 26 is positioned around the outer wall 24 of the tube 18 and the flavor ring 26 extends from the second end 22 toward the first end 20. Additionally, the flavor ring 26 may be comprised of an edible material

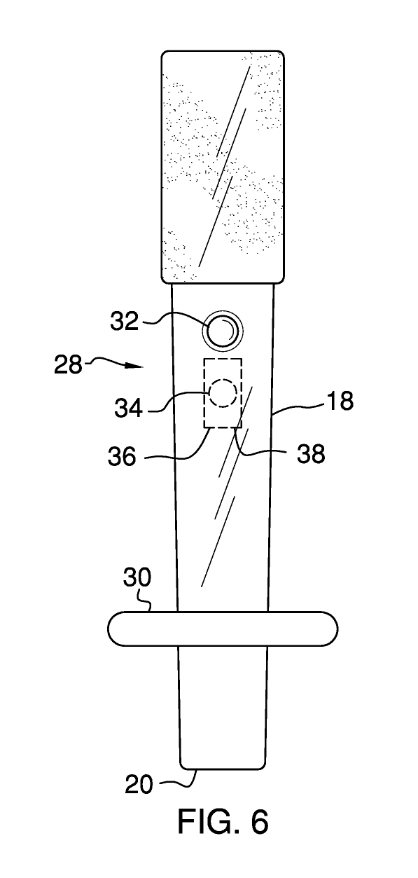

In an alternative embodiment 28 as shown in FIG. 6 a stopper 30 may be positioned around the tube 18. The stopper 30 may be positioned closer to the first end 20 then the second end 22. The stopper 30 may abut the distal end 16 of the hose 14 when the tube 18 is inserted into the hose 14. A light emitter 32 may be coupled to the tube 18 and the light emitter 32 may selectively emit light outwardly therefrom. The light emitter 32 may be an LED or the like. A button 34 may be coupled to the outer wall 24 the tube 18 and the button 34 is selectively manipulated. The button 34 may be electrically coupled to the light emitter 32 to turn the light emitter 32 on and off. A power supply 36 may be positioned within the tube 18 in the power supply 36 may be electrically coupled to the button 34. The power supply 36 may comprise at least one battery 38.

In use, the first end 20 of the tube 18 is inserted into the distal end 16 of the whole is when the hookah 12 is smoked. The flavor ring 26 is positioned in the user's mouth when the user smokes the hookah 12 to enhance the flavor associated with smoking the hookah 12. The tube 18 is removed from the tube 18 when the hookah 12 is finished being smoked. Moreover, the tube 18 is selectively washed to remove residue that collects in the tube 18 from smoking hookah 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hookah mouthpiece system having a flavored candy attached thereto wherein said system is configured to enhance a flavor of smoking a hookah, said system comprising:
a hookah having a hose;
a tube being selectively inserted into said hose wherein said tube is configured to be sucked on for smoking said hookah; and
a flavor ring being wrapped around said tube wherein said flavor ring is configured to be positioned in a user's mouth when said hookah is smoked, said flavor ring being infused with a flavor wherein said flavor ring is configured to enhance a flavor associated with smoking said hookah.

2. The system according to claim 1, wherein said hose has a distal end with respect to said hookah, said distal end being open.

3. The system according to claim 1, wherein said tube has a first end, a second end and an outer wall extending therebetween, said outer wall tapering between said first end and said second and such that said first end has a diameter being less than a diameter of said second end.

4. The system according to claim 3, wherein said first end being inserted into a distal end of said hose until said outer wall of said tube frictionally engages said hose thereby forming a fluid impermeable seal with said hose.

5. The system according to claim 3, further comprising said flavor ring being positioned around said outer wall of said tube, said flavor ring extending from said second end toward said first end.

6. A hookah mouthpiece system having a flavored candy attached thereto wherein said system is configured to enhance a flavor of smoking a hookah, said system comprising:
a hookah having a hose, said hose having a distal end with respect to said hookah, said distal end being open;
a tube being selectively inserted into said hose wherein said tube is configured to be sucked on for smoking said hookah, said tube having a first end, a second end and an outer wall extending therebetween, said outer wall tapering between said first end and said second and such that said first end has a diameter being less than a diameter of said second end, said first end being inserted into said distal end of said hose until said outer wall of said tube frictionally engages said hose thereby forming a fluid impermeable seal with said hose; and
a flavor ring being wrapped around said tube wherein said flavor ring is configured to be positioned in a user's mouth when said hookah is smoked, said flavor ring being infused with a flavor wherein said flavor ring is configured to enhance a flavor associated with smoking said hookah, said flavor ring being positioned around said outer wall of said tube, said flavor ring extending from said second end toward said first end.
